(19) United States
(12) Patent Application Publication
(10) Pub. No.: US 2013/0029716 A1
(43) Pub. Date: Jan. 31, 2013

(54) APPARATUS AND METHOD FOR PERFORMING GROUP-BASED M2M COMMUNICATION

(71) Applicants: Jin Lee, Anyang-si (KR); In Uk Jung, Anyang-si (KR); Gi Won Park, Anyang-si (KR); Young Soo Yuk, Anyang-si (KR)

(72) Inventors: Jin Lee, Anyang-si (KR); In Uk Jung, Anyang-si (KR); Gi Won Park, Anyang-si (KR); Young Soo Yuk, Anyang-si (KR)

(73) Assignee: LG ELECTRONICS INC., Seoul (KR)

(21) Appl. No.: 13/641,033

(22) PCT Filed: Apr. 12, 2011
(86) PCT No.: PCT/KR2011/002551

§ 371 Date: Oct. 12, 2012

Related U.S. Application Data
(60) Provisional application No. 61/323,339, filed on Apr. 12, 2010.

(51) Int. Cl. H04W 4/08

(52) U.S. Cl. 455/519

(57) ABSTRACT

Disclosed are an apparatus and method for performing group-based machine to machine (M2M) communication. According to one embodiment of the present invention, a method in which a plurality of M2M communication devices from a group, and a specific M2M communication device which is a member of the group performs communication with a base station, comprises the following steps: transmitting, to the base station, a first message for requesting network registration; receiving, as a response to the first message, a second message containing information on the representative M2M communication device which is a representative of the group; and transmitting, to the representative M2M communication device, data to be transmitted to the base station on the basis of the second message.

### TECHNICAL FIELD

The present invention relates to an apparatus and method for performing group-based M2M communication.

### BACKGROUND ART

Machine-to-Machine (M2M) communication refers to communication between an electronic device and another electronic device. In a broad sense, M2M communication refers to wire or wireless communication between electronic devices or communication between a machine and a device controlled by a person. However, it is general that M2M communication recently refers to wireless communication between electronic devices, i.e., devices performed without control of a person.

In the early 1990s when M2M communication has been introduced, M2M communication has been recognized as remote control or telematics and M2M communication markets have been very restrictive. However, M2M communication markets have received attention all over the world since M2M communication had been able to grow rapidly for last several years. Particularly, M2M communication has exerted its great influence at point of sales (POS) and security related application markets in the fields of fleet management, remote monitoring of machine and facilities, measurement of working time on construction machine facilities, and smart meter automatically measuring heat or the use of electricity. It is expected that M2M communication will be used for various purpose of uses in association with the existing mobile communication and low power communication solutions such as wireless high-speed Internet, Wi-Fi, and Zigbee and that its coverage will be extended to business to consumer (B2C) markets without limitation to business to business (B2B) markets.

In the M2M communication age, since all machines provided with a subscriber identity module (SIM) card may be able to perform data transmission and reception, they may remotely be controlled. For example, M2M communication technologies may be used for many machines and equipments such as cars, trucks, trains, containers, vending machines, and gas tanks. In this way, application ranges of M2M communication technologies are very broad.

According to the related art, since it was general that a mobile station was controlled separately, communication between a base station and a mobile station has been performed by a one-to-one communication mode. Supposing that many M2M devices perform communication with a base station through such a one-to-one communication mode, network overload will be caused by signaling generated between each of the M2M devices and the base station. As described above, if M2M communication is rapidly spread and widely used, a problem may occur due to overhead caused by communication between M2M devices or between each of the M2M devices and the base station. In this respect, a communication scheme for efficiently solving the overhead problem considering features of the M2M communication system has been required.

### DESCRIPTION OF THE INVENTION

### Technical Problems

An object of the present invention devised to solve the conventional problem is to provide a method for performing communication in a specific machine to machine (M2M) communication device of a group, which is formed by a plurality of M2M communication devices, with a base station.

Another object of the present invention is to provide a method for performing communication in a member of a group, that is, a specific machine to machine (M2M) communication device, with a base station, wherein the group is formed by a plurality of M2M communication devices.

Still another object of the present invention is to provide a method for performing communication in a base station with a main M2M communication device of a plurality of M2M communication devices constituting a group.

Further still another object of the present invention is to provide a base station for performing communication with a main M2M communication device of a plurality of M2M communication devices constituting a group.

Further still another object of the present invention is to provide a specific M2M communication device of a plurality of M2M communication devices constituting a group, for performing communication with a base station.

### Technical Solutions

To solve the aforementioned technical problems, according to one embodiment of the present invention, in a method for performing group-based machine to machine (M2M) communication, in which a plurality of M2M communication devices form a group and a specific M2M communication device of the group performs communication with a base station, the method comprises the steps of receiving, a message indicating that the specific M2M communication device is a head of the group, from the base station; receiving data from one or more member M2M communication devices included in the group; and transmitting the received data to the base station.

The method may further comprise the step of transferring a bandwidth request message received from the one or more member M2M communication devices to the base station, wherein the received data may be transmitted through a resource allocated by the base station for the one or more member M2M communication devices. The M2M communication devices forming the group may have same M2M communication type for performing same application.

According to another embodiment of the present invention, in a method for performing group-based machine to machine (M2M) communication, in which a plurality of M2M communication devices form a group and a specific M2M communication device of the group performs communication with a base station, the method comprises the steps of transmitting a first message for requesting network registration to the base station; receiving, a second message including information on a head M2M communication device of the group, in response to the first message; and transferring data for transmitting to the base station, to the head M2M communication devices based upon the second message.

In the method, the second message may further includes transmission power value information used for data transmission from the specific M2M communication device to the head M2M communication device, and the data may be transmitted to the head M2M communication device based upon the transmission power value information. Information on a transmission power adjustment value for the transmission power value may further be transmitted during data transmission.

The method may further comprise the steps of transmitting a third message for bandwidth request to the head M2M communication device based upon the second message; and receiving a fourth message including resource allocation information for data transmission, from the base station in response to the third message, wherein the step of transmitting data may include transferring the data to the head M2M communication device through a resource allocated by additionally using the fourth message.

According to still another embodiment of the present invention, in a method for performing group-based machine to machine (M2M) communication, in which a plurality of M2M communication devices form a group and a specific M2M communication device of the group performs communication with a base station, the method comprises the steps of transmitting data to a head M2M communication device of the group; transmitting a first message requesting to update the head M2M communication device of the group, to the base station if an acknowledgement (ACK) message is not received from the head M2M communication device in response to the data transmitted to the head M2M communication device of the group; and receiving, a second message including information on an updated head M2M communication device of the group, from the base station in response to the first message. The first message may be transmitted if the ACK message is not received from the base station as much as the number of times previously determined for data transmitted to the head M2M communication device several times.

According to further still another embodiment of the present invention, in a method for performing group-based machine to machine (M2M) communication, in which a plurality of M2M communication devices form a group and an M2M communication device of the group performs communication with a base station, the method comprises the steps of receiving, a first message for requesting to update a head M2M communication device of the group, from a specific member M2M communication device not the head M2M communication device of the group; determining a new head M2M communication device of the group based upon the first message; and transmitting, a second message including information on the new head M2M communication device, to the specific member M2M device, in response to the first message.

According to further still another embodiment of the present invention, in a method for performing group-based machine to machine (M2M) communication, in which a plurality of M2M communication devices form a group and a head M2M communication device of the group performs communication with a base station, the method comprises the steps of transmitting a first message for presence check of one or more M2M communication devices of the group, to the one or more M2M communication devices; and transmitting a second message requesting to update member M2M communication device information of the group, to the base station if an acknowledgement (ACK) message of the first message is not received from the one or more M2M communication devices.

The method may further comprise the step of receiving, a third message including updated information for the member M2M communication device of the group, in response to the second message. The second message may be transmitted if there is a member M2M communication device that does not transmit the ACK message as much as the number of times previously determined for the first message transmitted several times. The second message may include information on the member M2M communication device that does not transmit the ACK message in response to the first message.

According to further still another embodiment of the present invention, in a method for performing group-based machine to machine (M2M) communication, in which a base station performs communication with a head M2M communication device of a plurality of M2M communication devices forming a group, the method comprises the steps of receiving a first message for requesting to update member M2M communication device information of the group from the head M2M communication device of the group; updating the member M2M communication device information based upon the first message; and transmitting a second message including information on the updated member M2M communication device, to the head M2M communication device, wherein the first message includes information on an M2M communication device that does not transmit the ACK message in response to a third message transmitted for presence check from one or more M2M communication devices.

The method may further comprise the steps of transmitting a fourth message for presence check to the member M2M communication device that does not transmit ACK message; and if the ACK message is not received in response to the fourth message, performing deregistration of context maintained with the member M2M communication device that does not transmit the ACK message.

According to further still another embodiment of the present invention, in a base station for performing group-based machine to machine (M2M) communication with a head M2M communication device of a plurality of M2M communication devices forming a group, the base station comprises a receiver configured to receive a first message requesting to update member M2M communication device information of the group from the head M2M communication device of the group; a processor configured to update the member M2M communication device information based upon the first message; and a transmitter configured to transmit a second message including information on the updated member M2M communication device, to the head M2M communication device, wherein the first message includes information on an M2M communication device that does not transmit the ACK message in response to a third message transmitted for presence check from one or more M2M communication devices.

According to further still another embodiment of the present invention, in a machine to machine (M2M) communication device perform communication with a base station, in which a group is formed by a plurality of M2M communication devices, the M2M communication device comprises a receiver configured to receive a message indicating that the M2M communication device is a head device of the group, from the base station and to receive data from one or more member M2M communication devices included in the group; and a transmitter transmitting the received data to the base station.

### Advantageous Effects

According to the embodiments of the present invention, for efficiency of management in performing a service for a plurality of M2M devices, a group is formed by one or more M2M devices and a head device of the corresponding group is defined to perform communication between the M2M device and a base station, whereby signaling and resource overhead may be reduced significantly.

Also, the current status of the M2M device may be checked through the head device, and if the group head device fails in data transmission, the current status of the member M2M devices quickly is checked quickly, whereby communication throughput between the M2M devices and the base station may be improved remarkably.

It will be appreciated by persons skilled in the art that that the effects that could be achieved with the present invention are not limited to what has been particularly described hereinabove and other advantages of the present invention will be more clearly understood from the following detailed description. In other words, the effects that are not intended by the present invention may be devised from the embodiments of the present invention by persons skilled in the art.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a brief diagram illustrating configurations of an machine to machine (M2M) device and a base station according to one embodiment of the present invention;

FIG. 2 is a diagram illustrating a concept of group based M2M communication according to one embodiment of the present invention;

FIG. 3 is a diagram illustrating a procedure of performing initial network entry between an M2M device and a base station in accordance with one embodiment of the present invention;

FIG. 4 is a brief diagram illustrating a method for selecting an M2M device initiated group head according to one embodiment of the present invention;

FIG. 5 is a brief diagram illustrating a method for selecting a base station initiated group head according to one embodiment of the present invention;

FIG. 6 is a diagram illustrating an example of an element of M2M group ID in accordance with one embodiment of the present invention;

FIG. 7 is a diagram illustrating an example of performing communication between M2M devices by forming a base station initiated M2M group and selecting a group head;

FIG. 8 is a diagram illustrating another example of performing communication between M2M devices by forming a base station initiated M2M group and selecting a group head;

FIG. 9 is a diagram illustrating an example of performing communication in an M2M device of an M2M group;

FIG. 10 is a diagram illustrating an example of a method for data transmission of member M2M devices when a group head device of an M2M group fails in data transmission;

FIG. 11 is a diagram illustrating an example of a method for checking the current presence of M2M devices based on a group head M2M device; and

FIG. 12 is a diagram illustrating another example of a method for checking the current presence of M2M devices based on a group head M2M device.

### BEST MODE FOR CARRYING OUT THE INVENTION

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. The following detailed description includes detailed matters to provide full understanding of the present invention. However, it will be apparent to those skilled in the art that the present invention can be carried out without the detailed matters.

Meanwhile, in some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

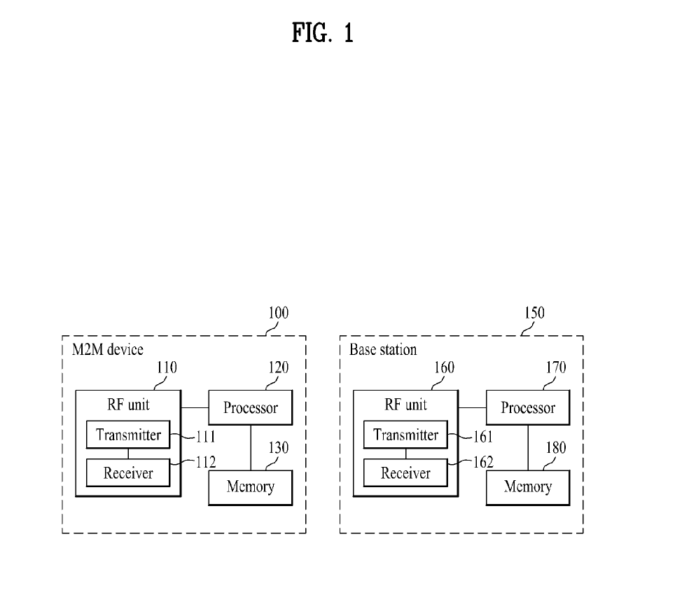

FIG. 1 is a brief diagram illustrating configurations of an M2M device and a base station according to the embodiment of the present invention.

In FIG. 1, each of an M2M device 100 (or M2M communication device) and a base station 150 may include a radio frequency (RF) unit 110, 160, and a processor 120, 170. Each of the M2M device and the base station may selectively include a memory 130, 180. Each RF unit 110, 160 may include a transmitter 111, 161 and a receiver 112, 162. In case of the M2M device 100, the transmitter 111 and the receiver 112 may be configured to transmit and receive a signal to and from the base station 150 and other M2M devices, and the processor 120 may be functionally connected with the transmitter 111 and the receiver 112 to control the signal transmission and reception procedure of the transmitter 111 and the receiver 112 to and from other devices. Also, the processor 120 performs various kinds of processing for a signal for transmission and then transmits the processed signal to the transmitter 111, and may perform processing for the signal received by the receiver 112. The processor 120 may store information included in the exchanged message in the memory 130 if necessary. The M2M device 100 configured as above may perform methods of various embodiments which will be described later.

Although not shown in FIG. 1, the M2M device 100 may include various additional elements in accordance with its device application type. If the corresponding M2M device 100 is for smart metering, it may include additional element for power measurement. An operation for power measurement may be controlled by the processor 120 shown in FIG. 1, or may be controlled by a separate processor (not shown).

Although FIG. 1 illustrates an example of communication performed between the M2M device 100 and the base station 150, a method for M2M communication according to the present invention may be performed between the M2M devices, each of which may perform the method according to various embodiments, which will be described later, in the same manner as each device shown in FIG. 1.

In case of the base station 150, the transmitter 161 and the receiver 162 may be configured to transmit and receive a signal to and from another base station, M2M server and M2M devices, and the processor 170 may be functionally connected with the transmitter 161 and the receiver 162 to control the signal transmission and reception procedure of the transmitter 161 and the receiver 162 to and from other devices. Also, the processor 170 performs various kinds of processing for a signal for transmission and then transmits the processed signal to the transmitter 161, and may perform processing for the signal received by the receiver 162. The processor 170 may store information included in the exchanged message in the memory 180 if necessary. The base station 150 configured as above may perform methods of various embodiments which will be described later.

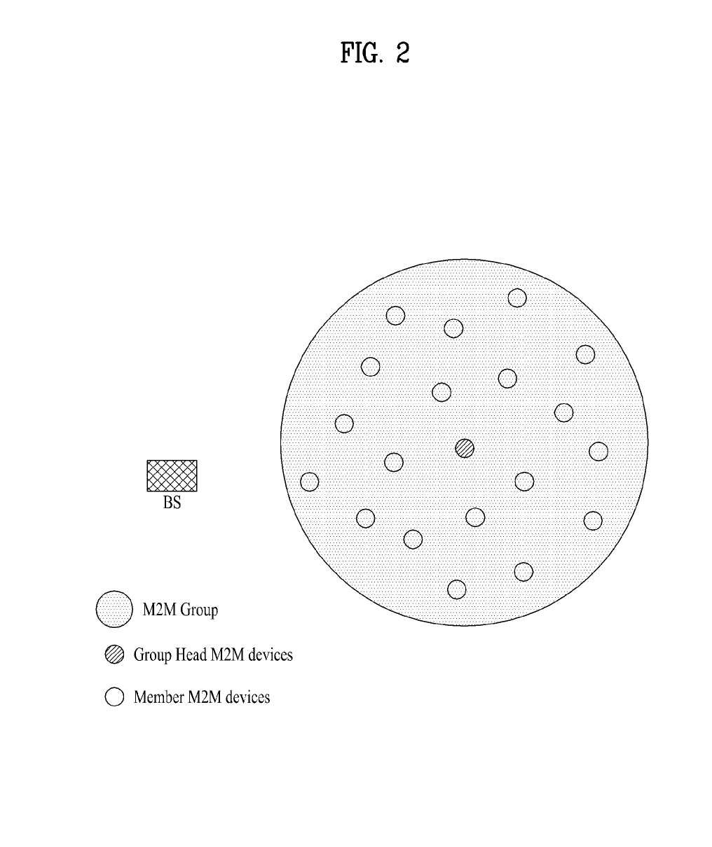

FIG. 2 is a diagram illustrating a concept of group based M2M communication according to one embodiment of the present invention.

M2M group means that M2M devices, which belong to similar M2M application (similar data traffic transport patterns) servers and same M2M subscribers, constitute one group. The M2M devices which belong to same M2M group require group identifier (M2M group ID) representing the corresponding group.

M2M based communication devices (that may be referred to as various terms such as M2M devices and M2M communication devices) will be increased gradually in a certain network as their device application types are increased. Examples of device application types, which are discussed, include, but not limited to, (1) security, (2) public safety, (3) tracking and tracing, (4) payment, (5) healthcare, (6) remote maintenance and control, (7) metering, (8) consumer device, (9) fleet management at POS (Point Of Sales) and security related application market, (10) communication between devices of a vending machine, (11) remote controlling of machine and facilities, measurement of working time on construction machine facilities, and smart meter automatically measuring heat or the use of electricity, and (12) surveillance video communication of a surveillance camera. Other various device application types are being discussed.

As described above, as the device application types are increased, the number of M2M communication devices may be increased more rapidly than the number of general mobile communication devices. Accordingly, if the communication devices respectively perform communication with a base station, serious load may be caused in a wireless interface. It is likely that collision occurs in accordance with a scheduling mode of the base station.

Also, another feature of the M2M communication system is low mobility as compared with the existing wireless communication system. For example, an M2M device for smart metering, which automatically measures the use of electricity, automatically measures the use of electricity of a corresponding location under ordinary conditions in its initial installation location and transmits data to an M2M server periodically (or if a specific event occurs), wherein the M2M server controls corresponding automatic metering. Accordingly, in the aforementioned example, in view of the base station that has received a message indicating that the automatic measurement period of the use of electricity has been changed or scheduling information on the M2M devices has been changed, from the M2M server, instead of transmitting this scheduling information change to each M2M device, if the M2M devices form groups and notifies a head M2M device (hereinafter, referred to as a group head but various terms may be used) of each group of the scheduling information change and then the group head M2M device notifies the M2M devices within the corresponding group of the scheduling information change, the load problem of the wireless interface will efficiently be solved.

FIG. 2 briefly illustrates that the group head is selected from the network where the M2M devices exist, in accordance with the aforementioned concept, to form a group. The M2M device selected as the group head may perform uplink and/or downlink signal transmission and reception to and from the base station on behalf of the group. Also, the group head may collect the signals (data) received from the respective M2M devices and report the collected signals to the base station in such a way to minimize overhead. The base station that has received the signals may transfer the signals to the corresponding M2M server.

Hereinafter, according to one embodiment of the present invention, a method for selecting a group head representing a group will be described as the first step for forming a group between M2M devices in an M2M communication environment. The method for selecting a group head may include a method for selecting a group head based on the M2M device and a method for selecting a group head based on the base station BS. Hereinafter, in the following description, although the M2M communication scheme is performed in combination with a mobile communication system according to the IEEE 802.16m standard, it is not limited to the above example. Namely, the M2M communication scheme may be used in combination with various mobile communication techniques. First of all, the method for selecting a group head based on the M2M device will be described.

<Method for Selecting M2M Device Based Group Head>

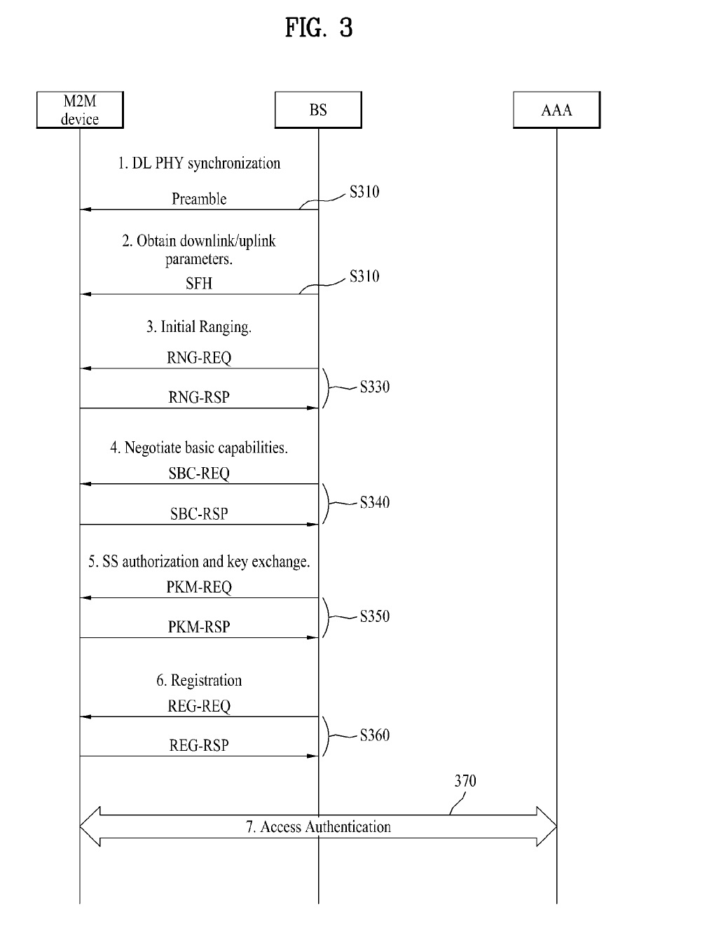

FIG. 3 is a diagram illustrating a procedure of performing initial network entry between an M2M device and a base station in accordance with one embodiment of the present invention.

First of all, the M2M device may acquire downlink synchronization by receiving a downlink physical (DL PHY) synchronization preamble from the base station (S310). Then, the M2M device may acquire downlink/uplink parameters by receiving a super frame header (SFH) transmitted to the downlink (S320).

Afterwards, the M2M device may exchange an initial ranging request/response (RNG-REQ/RSP) message with the base station (S330). This embodiment suggests that RNG-REQ/RSP which includes information as illustrated in Table 1 below is used during the procedure of performing initial ranging.

TABLE 1

| Name | Value | usage |
|---|---|---|
| ~ | — | — |
| M2M device location | ‘1’ GPS information | |
| information | available | |
| indicator | ‘0’ GPS information | |
| | not available | |
| M2M device location | Location | Include when the |
| information | information: | M2M device location |
| | Latitude | information |
| | Longitude | indicator is ‘1’ |
| | Or Other coordinate | |
| | system | |
| | MS Speed | |
| ~ | — | — |

In other words, this embodiment suggests that the M2M device notifies the base station of its location information during the initial network entry procedure. The base station may decide to form a group of the M2M devices by considering the location information of the M2M device. In the embodiment of FIG. 2, the location information of the M2M device is notified to the base station during the initial ranging procedure. The location information of the M2M device may be added to a later registration procedure.

In the meantime, after completing ranging, the M2M device may exchange SBC-REQ/RSP message with the base station as a negotiation procedures of basic capabilities (S340), and perform a password key setting procedure (S350). Afterwards, the M2M device may exchange a registration request/response (REG-REQ/RSP) message with the base station and perform a network registration procedure (S360). One embodiment of the present invention suggests that the M2M device notifies the BS of its device application type by using messages, which include information as illustrated in Table 2 and Table 3 below, as the network registration request/response messages.

TABLE 2

| Name | Value | usage |
|---|---|---|
| ~ | — | — |
| Machine Application | 0: Fleet | |
| Type | Management | |
| | 1: Vending Machine | |
| | 2: Smart Metering | |
| | 3: Surveillance | |
| | Video | |
| | 4 ~xxx: Reserved | |
| ~ | — | — |

TABLE 3

| Name | Value | usage |
|---|---|---|
| ~ | — | — |
| Machine Application | 0: Fleet | |
| Type | Management | |
| | 1: Vending Machine | |
| | 2: Smart Metering | |
| | 3: Surveillance | |
| | Video | |
| | 4 ~xxx: Reserved | |
| DID (Device ID) | | ID allocated from |
| | | network during |
| | | Registration |
| | | procedure of |
| | | Network entry. The |
| | | network identifies |
| | | M2M device through |
| | | DID. |
| ~ | — | — |

Table 2 illustrates AAI-REG-REQ message as an example of the registration request message, and Table 3 illustrates AAI-REG-RSP message as an example of the registration response message. In more detail, in Table 2 and Table 3, examples of the M2M device application type include, but not limited to, fleet management, communication between devices of a vending machine, smart meter, and surveillance video communication of a surveillance camera. Also, Table 3 illustrates that the registration response message includes device ID (DID, identifier used to identify the M2M device from the network). In other words, the M2M device may be allocated with DID through the network registration procedure, wherein the DID may perform the same function as “Station ID” in the IEEE 802.16m standard. After performing the above procedure, the M2M device may perform an authentication procedure with the base station (S370).

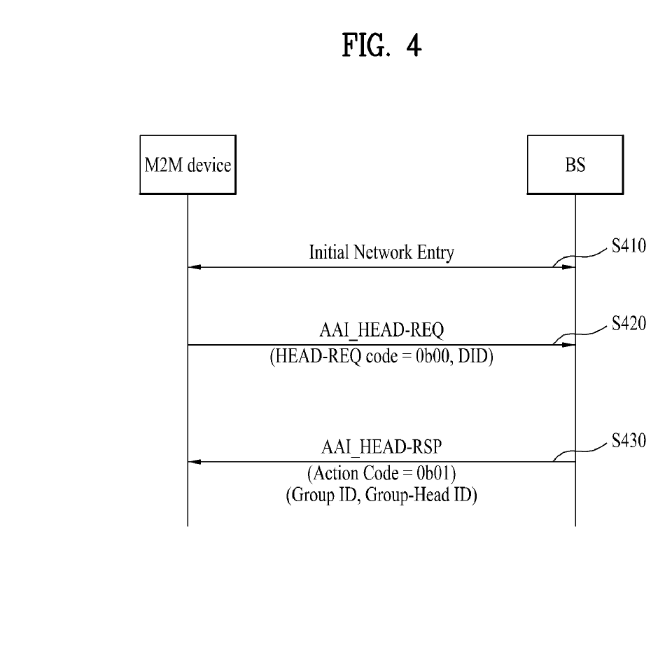

FIG. 4 is a brief diagram illustrating a method for selecting an M2M device based group head according to one embodiment of the present invention.

As shown in FIG. 4, after the M2M device performs the initial network entry procedure with the base station as described with reference to FIG. 2 (S410), if it determines that it is suitable for a group head, it may transmit AAI_HEAD-REQ message to the base station and request the base station to select the M2M device as the group head (S420). The conditions determined by the M2M device that the M2M device is suitable for the group head may be as follows:

1) the case where the battery headroom of the device is sufficient;

2) the case where values of received signal strength indicator (RSSI) and carrier to interference and noise ratio (CINR) are sufficiently good on the basis of the signal transmitted and received to and from the base station during the initial network entry procedure; and

3) the case where the base station is sufficiently close to the M2M device (on the assumption that the M2M device knows its location information and location information of the base station due to a GPS installed therein).

The M2M device may consider additional condition to the aforementioned conditions or the other conditions equivalent to the aforementioned conditions.

In the meantime, after receiving the AAI_HEAD-REQ message, if the base station determines that the requested M2M device is suitable for the group head, it may transmit AAI_HEAD-RSP message and notify that the corresponding M2M device has been selected as the group head (S330). At this time, the base station may consider the location information of the M2M device, battery information, signal quality information, device application type, etc. as notified from the M2M device during the initial network entry procedure.

<Method for Selecting a BS Based Group Head>

This embodiment discloses a method for selecting group head based on the base station.

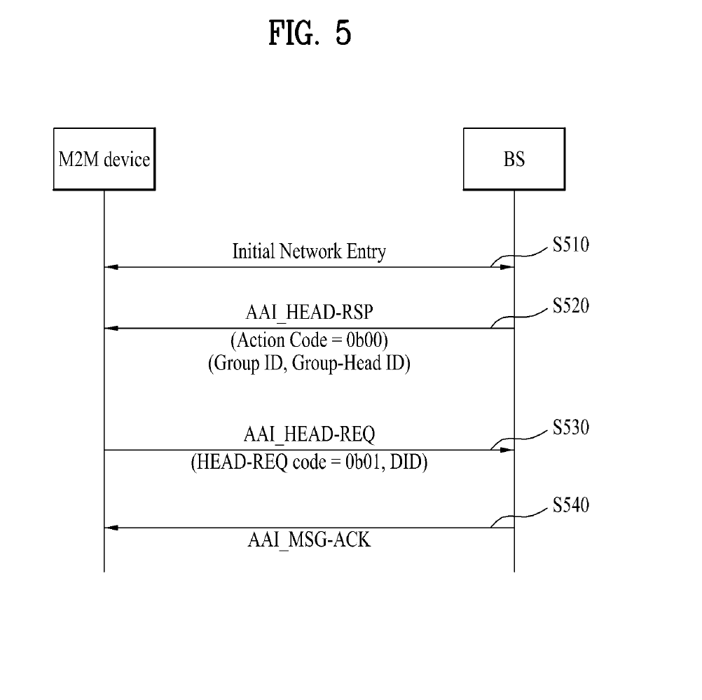

FIG. 5 is a brief diagram illustrating a method for selecting a base station based group head according to one embodiment of the present invention.

As shown in FIG. 5, first of all, the M2M device may perform the initial network entry procedure (S510) as described with reference to FIG. 3.

Afterwards, the base station may select a group head of M2M devices, which have accessed thereto, that is, have completed network entry, and may notify the corresponding M2M device that the corresponding M2M device has been selected as the group head. The base station may consider the following conditions for determining that the M2M device is suitable for the group head:

1) the device having sufficient battery headroom;

2) device having RSSI and CINR of which values are sufficiently good on the basis of the signals transmitted and received between the base station and the M2M device during the initial network entry procedure;

3) M2M device sufficiently close to the base station (on the assumption that the M2M device knows its location information and location information of the base station due to a GPS installed therein); and

4) the other condition.

The base may transfer AAI_HEAD-RSP message, which includes group ID and group head ID, to the device selected as the group head (S520). An example of the AAI_HEAD-RSP message may include a structure as illustrated in Table 4 below.

TABLE 4

| Syntax | Size | Notes |
|---|---|---|
| AAI_HEAD- | — | — |
| RSP_Message_format ( | | |
| ) { | | |
| Action Code | | Used to indicate the purpose |
| | | of this message |
| | | 0b00: M2M device shall begin |
| | | Group-Head initiation |
| | | (signal M2M device to begin |
| | | Group-Head initiation in |
| | | unsolicited manner |
| | | 0b01: This option is valid |
| | | only in response to a |
| | | AAI_HEAD-REQ message with |
| | | HEAD-REQ Code 0b00 (to allow |
| | | M2M device-initiated Group- |
| | | Head request) |
| | | 0b10: This option is valid |
| | | only in response to a |
| | | AAI_HEAD-REQ message with |
| | | HEAD-REQ Code 0b00 (to |
| | | reject M2M device-initiated |
| | | Group-Head request) |
| | | 0b11: reserved |
| Group-Head ID | | Used to indicate Group-Head |
| | | ID used to identify Group- |
| | | Head in Network |
| Group ID | | Used to indicate Group ID |
| | | used to identify M2M Group |
| | | in Network |
| ~ | — | — |

As illustrated in Table 4, examples of action code include action code 0b00 indicating that the corresponding AAI_HEAD-RSP message is transmitted from the base station to the M2M device in accordance with the base station based group head selection scheme and then the operation of the M2M device is initiated as the group head, action code 0b01 indicating that the corresponding AAI_HEAD-RSP message is a response message allowing the M2M device to be operated as the group head in accordance with the M2M device based group head selection scheme in response to the request of group head selection, and action code 0b10 indicating that the corresponding AAI_HEAD-RSP message is a response message rejecting the M2M device to be operated as the group head in response to the request of the M2M device. FIG. 4 illustrates that the base station transmits AAI_HEAD-RSP message having action code of 0b00 to the M2M device. Also, the base station may transmit the AAI_HEAD-RSP message, which includes group ID and ID of the M2M device selected as the group head, to the M2M device.

In the meantime, the M2M device that has received the aforementioned AAI_HEAD-RSP message may transmit the AAI_HEAD-REQ message to the base station in response to the AAI_HEAD-RSP message (S530). In this embodiment, the AAI_HEAD-REQ message may include a structure as illustrated in Table 5 below.

TABLE 5

| Syntax | Size | Notes |
|---|---|---|
| AAI_HEAD- | — | — |
| RSP_Message_format ( | | |
| ) { | | |
| HEAD_REQ Code | | Used to indicate the purpose |
| | | of this message |
| | | 0b00: M2M device initiated |
| | | Group-Head request |
| | | 0b01: Response (accept) for |
| | | the unsolicited AAI_HEAD-RSP |
| | | message with action code 0x00 |
| | | by the ABS. |
| | | 0b10: reject for the |
| | | unsolicited AAI_DREG-RSP |
| | | message with action code 0x00 |
| | | by the ABS. |
| | | 0x11: reserved |
| DID (Device ID) | | ID allocated from network |
| | | during Registration procedure |
| | | of Network entry. The network |
| | | identifies M2M device through |
| | | DID. |
| ~ | — | — |

As illustrated in Table 5, examples of action code of the AAI_HEAD-REQ message include action code 0b00 indicating that the AAI_HEAD-REQ message is the message of the M2M device initiated group head request, and action code 0b01/0b10 indicating that the AAI_HEAD-REQ message is a grant/rejection message of the base station initiated group head request. In the example of FIG. 4, it is assumed that the AAI_HEAD-REQ message of action code of 0b01 is transmitted to the BS. Also, if the M2M device determines that it is suitable for the group head, it may transmit AAI_HEAD-REQ (HEAD-REQ code=0b01), which includes its DID, to the base station.

Then, the base station may transfer ACK message to the M2M device in response to the AAI_HEAD-REQ message (S540). The M2M device that has successfully received the MSG-ACK may perform uplink/downlink communication with the base station as the group head on behalf of the corresponding group.

As described above, since it is expected that network overload will occur due to signaling caused between each M2M device and the base station, a procedure of simplifying signaling by forming the group of the M2M devices and reducing radio interface load will be required. Also, since group management of the M2M device has not been defined in the related art, a procedure of identifying the status of the devices which belong to the group has not been defined. Accordingly, supposing that the M2M devices maintain an idle state for most of a life time, if the network does not check the presence of the M2M devices periodically, delay may occur in identifying a wrong status of the M2M device and solving the wrong status of the M2M device.

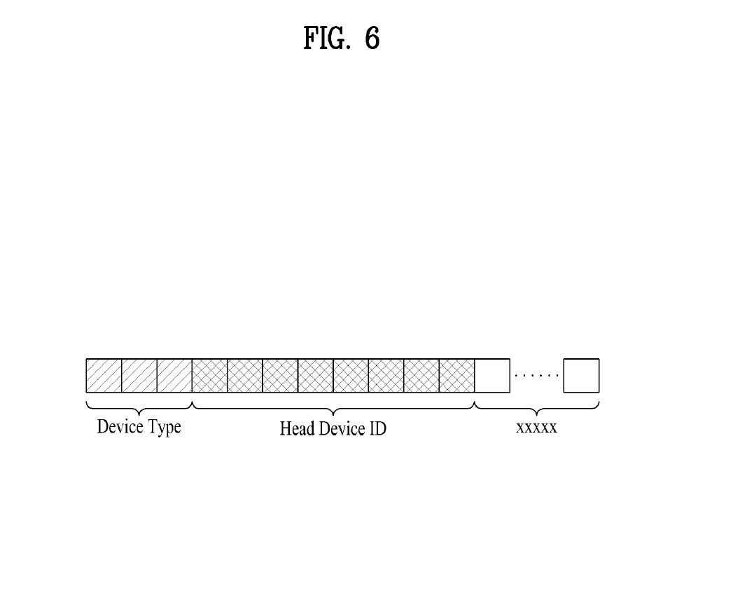

FIG. 6 is a diagram illustrating an example of an element of M2M group ID in accordance with one embodiment of the present invention.

Identifier of each group is required in forming groups of M2M devices due to network overload, radio interface overload, etc. Identifier for identifying these groups will be referred to as group ID. As shown in FIG. 6, M2M group ID information may include application category information and information on a head device (for example, head ID), which are served by the corresponding M2M device. In other words, a head device of a group or M2M application type may be estimated from the M2M group ID. However, this method may be performed when the M2M group has a fixed head device. M2M device type (or M2M application type) included in the M2M group ID may indicate various kinds of application information such as (1) security, (2) public safety, (3) tracking and tracing, (4) payment, (5) healthcare, (6) remote maintenance and control, (7) metering, (8) consumer device, (9) fleet management at POS (Point Of Sales) and security related application market, (10) communication between devices of a vending machine, (11) remote controlling of machine and facilities, measurement of working time on construction machine facilities, and smart meter automatically measuring heat or the use of electricity, and (12) surveillance video communication of a surveillance camera, at a predetermined bit size.

The aforementioned group head device (or head device) means M2M device representing one M2M group. The group head device ID may be expressed by 24 bit size, for example. Hereinafter, M2M group management and functions of the M2M group head device will be described in more detail.

It is assumed that M2M device 1, M2M device, 2 and M2M device 3 exist in one M2M group (group A). In this case, it is assumed that the M2M device 1 is a head device of the group A. The method for determining a head device includes the method for determining a base station initiated head device and the method for determining an M2M device initiated head device as described above. Initial network entry of all the M2M devices (M2M device 1, M2M device 2 and M2M device 3) which belong to the group A is performed directly for the base station, and as a result, the M2M group is formed. In other words, initial network entry of all the M2M devices is performed for the base station.

<Embodiment of Performing Communication Between M2M Devices by Forming a Base Station Initiated M2M Group and Selecting a Group Head>

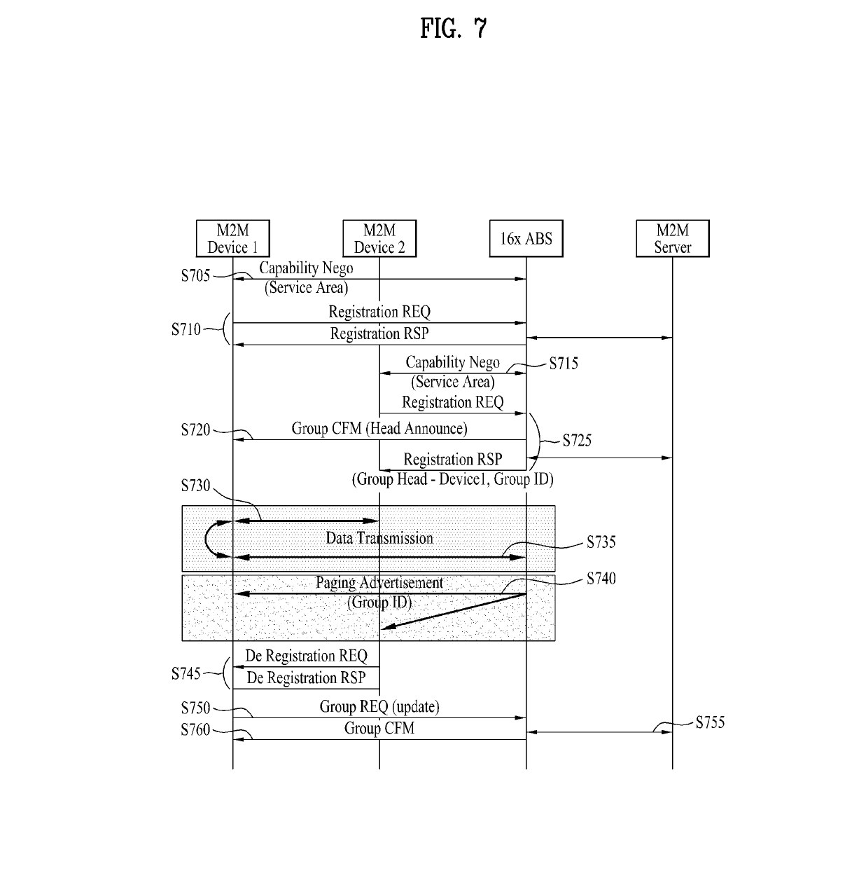

FIG. 7 is a diagram illustrating an example of performing communication between M2M devices by forming a base station initiated M2M group and selecting a group head.

Referring to FIG. 7, the M2M device 1 may perform a network entry procedure to the base station (for example, base station of the IEEE 802.16p system). The M2M device 1 may transfer its service area category information (for example, application type) to the base station during a capability negotiation procedure (S705). This procedure is to notify device features to allow the base station to later apply similar QoS or policies to devices which belong to the same group. Afterwards, the M2M device 1 may exchange registration request/response (REG-REQ/RSP) messages with the base station and perform a network registration procedure (S710).

Also, the M2M device 2 may perform the network entry procedure for the base station (for example, base station of the IEEE 802.16p system) (S715). At this time, the M2M device 2 may also transfer its service area category information (for example, application type) to the base station during the capability negotiation procedure (S715). At this time, if the processor 170 of the base station determines that the service area of the M2M device 2 is the same as that of the M2M device 1 as a result of communication with the M2M server, it may manage the M2M device 2 in the same group as the M2M device 1. In this case, the processor 170 of the base station needs to determine a group head of this group, may determine the M2M device 1 as the group head as shown in FIG. 7. And, the base station may notify the M2M device 1 that the M2M device 1 has been selected as the group head, through a group confirm (CFM) message, etc. (S720). Accordingly, the M2M device 2 becomes a group head device, and the M2M device 1 becomes a member M2M device.

Afterwards, the M2M device 2 may also exchange registration request/response (REG-REQ/RSP) messages with the base station and perform the network registration procedure (S725). At this time, the base station may notify the M2M device 2 of information on a head device (that is, M2M device 1) of the group to which the M2M device 2 belongs and M2M group ID information through a registration response (RSP) message (S725). Selectively, the base station may further include information on group members in the registration response message to notify the M2M device 2 of the group member information (S725). Although the M2M device 1 and the M2M device 2 constitute one group (group A) in FIG. 7, more M2M devices may be included in the group A. The following Table 6 illustrates an example of information on M2M groups stored in the base station.

TABLE 6

| | | ID of M2M devices belonging |
|---|---|---|
| | | to this group, and list of |
| | Group | member M2M devices belonging |
| Group ID | head | to M2M group |
| A | M2M | M2M device 2 |
| | device 1 | |

Afterwards, the M2M device 2 which is a member M2M device may transmit data, which should be transmitted to the base station, to the M2M device which is a group head, if any (S730). Then, the M2M device 1 may collect the data received from the M2M device 2 and transmit the collected data to the base station (S735). In other words, the M2M device 1 which is a group head may serve to transmit data, which should be transmitted to the base station, instead of the member M2M devices belonging to the same group.

In the meantime, paging advertisement from the base station may be performed based on the group ID (S740). The M2M device 2 may perform a network deregistration procedure with the M2M device, which is a group head, through a control message (for example, deregistration request/response message (S745). Afterwards, the M2M device 1 which is a group head may transfer for a message for group update to the base station (S750), and may receive an acknowledgement message from the base station in response to the message for group update) S755). If the group update message is received from the M2M device 1, the base station may transfer the group update message to the M2M server (S760).

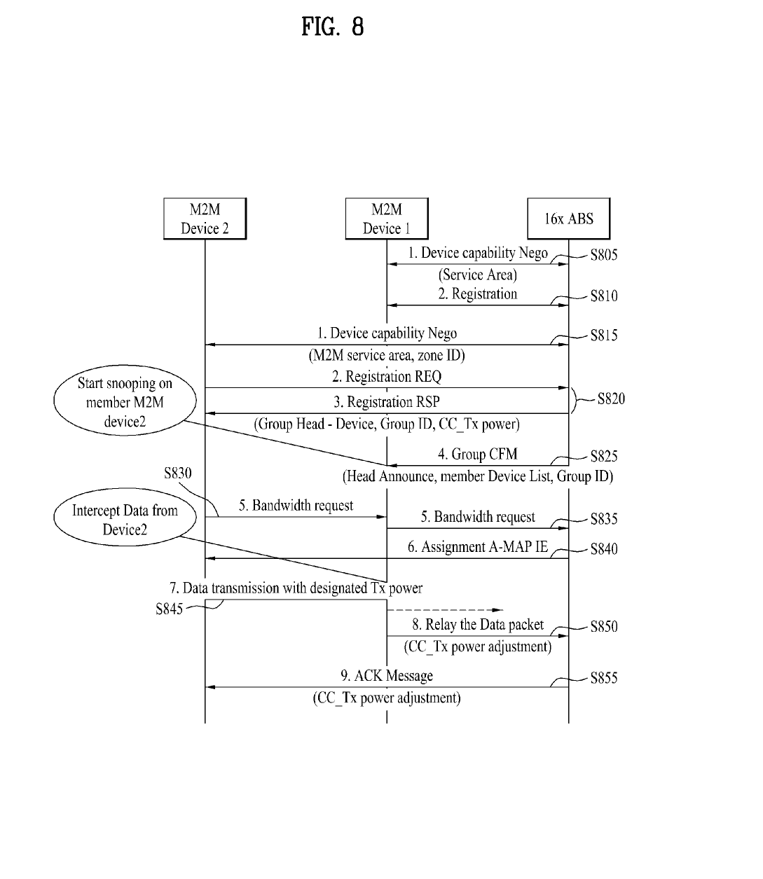

FIG. 8 is a diagram illustrating another example of performing communication between M2M devices by forming a base station initiated M2M group and selecting a group head.

Referring to FIG. 8, the M2M device 1 may perform a network entry procedure to the base station (for example, base station of the IEEE 802.16p system). The M2M device 1 may transfer its service area category information (for example, application type) and zone ID information to the base station during a capability negotiation procedure (S805). This procedure is to notify device features to allow the base station to later apply similar QoS or policies to devices which belong to the same group. Afterwards, the M2M device 1 may exchange registration request/response (REG-REQ/RSP) messages with the base station and perform a network registration procedure (S810).

Also, the M2M device 2 may perform the network entry procedure for the base station (for example, base station of the IEEE 802.16p system) (S815). At this time, the M2M device 2 may also transfer its service area category information (for example, application type) and zone ID information to the base station during the capability negotiation procedure (S815). And, the M2M device 2 may exchange network registration request/response (REG-REQ/RSP) messages with the base station and perform the network registration procedure (S820).

If the processor 170 of the base station determines that the service area and zone ID of the M2M device 2 are the same as those of the M2M device 1, it may manage the M2M device 2 in the same group as the M2M device 1. Then, the M2M device 2 automatically joins in the same group as that of the M2M device 1. In this case, the processor 170 of the base station needs to determine a group head of this group, may determine the M2M device 1 as the group head as shown in FIG. 8. And, the base station may notify the M2M device 2 of information on a group head device (that is, M2M device 1), group ID, group ID, information on a transmission power to be used during data transmission from the M2M device 2 to the M2M device 1 which is a group head device, etc., through the registration RSP message during the registration request/response procedure with the M2M device 2. In this case, the information on a transmission power to be used during data transmission from the M2M device 2 to the M2M device 1 may previously be defined and then may be notified from the base station. Generally, this transmission power may previously be set as a value lower than the transmission power used for data transmission from the M2M device, which is a member device, to the base station, and data communication of the M2M devices may be performed by this transmission power value. Preferably, this transmission power value may be applied to fixed M2M devices or M2M devices having low mobility.

Also, the base station may notify the M2M device 1 that the M2M device 1 has been selected as the group head, through a group confirm (CFM) message, for example (S825). Accordingly, the M2M device 2 becomes a group head device, and the M2M device 1 becomes a member M2M device. At this time, the group CFM message may include a list of member devices of the M2M group, group ID, etc. Although the M2M device 1 and the M2M device 2 constitute one group (group A) in FIG. 8 for convenience of description, more M2M devices may be included in the group A.

The M2M device 2 which is a member M2M device may transmit a message requesting a bandwidth to the M2M device 1 (S830), and the M2M device 1 which has received the message may transfer the received message to the base station (S835). Afterwards, the base station may transmit an assignment A-MAP IE, which includes assignment resource information, to the M2M device 2 (S840). Then, the M2M device 2 may transfer data, which is allocated at the step S820 and will be transmitted to the base station as a transmission power value to be used during data transmission, to the M2M device 1 (S845). At this time, the M2M device 2 may further transmit information on a transmission power adjustment value during data transmission if it desires to adjust the transmission power value assigned from the base station at the step S820 (S845). The M2M device 1 which has received the data from the M2M device 2 may relay the data to the base station (S850). At this time, if the M2M device 2 has further transmitted the information on a transmission power adjustment value during data transmission, the M2M device 1 may further relay the transmission power adjustment value to the base station (S850). The base station which has received the transmission power adjustment value may transmit ACK message to the M2M device 2 if it accepts the transmission power adjustment value (S855).

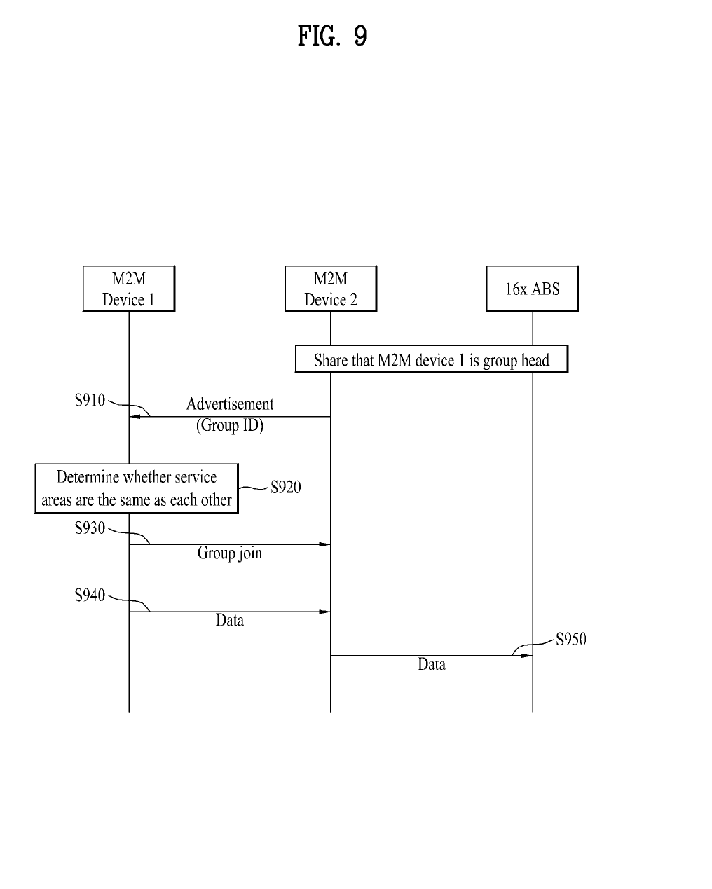

FIG. 9 is a diagram illustrating an example of performing communication in an M2M device of an M2M group.

In a scenario of this embodiment, it is assumed that the M2M group 1 is previously defined as a group head and the base station previously knows that the M2M group 1 is defined as the group head. The M2M device 1 may transmit an advertisement message, which indicates that the M2M device 1 is a group head, to its neighboring M2M devices (S910). The M2M device 2 may know that the M2M device 1 is a neighboring group head, on the basis of the advertisement message received from the M2M device 1. At this time, the advertisement message may include information on group ID, and the M2M device 2 may determine that its service area is the same as that of the M2M device 1, through the group ID (S920). If the service area of the M2M device 2 is the same as that of the M2M device 1, the M2M device 2 may transmit a group join request to the M2M device 1 (S930). Also, the M2M device 2 may transfer data, which will be transmitted to the base station, to the M2M device 1 which is a group head (S940), and the M2M device, which has received the data, may relay the data to the base station (S950).

As described above, the M2M devices may significantly reduce bandwidth request (BR) collision performed by the base station with a plurality of M2M devices by transmitting the data to the grouped head device. Since communication between member M2M devices within a group is not required essentially, the member M2M device may not know the presence of the other M2M devices within the group. However, if data transmission to the base station is failed due to the group head device, a problem may occur in that the member M2M device transfers desired data to the base station. In order to solve this problem, if the member M2M device fails to receive ACK message from the group head device in response to the data transmitted to the group head device, the M2M device may perform direct data transmission to the base station. At this time, the group head may transfer the failure status of data transmission to the base station. The base station that has received the failure status may newly select a head of the corresponding group, and may notify all the M2M devices belonging to group ID of information on the newly selected group head device.

Hereinafter, embodiments of a method for data transmission of member M2M devices when a group head device of an M2M group fails in data transmission will be described.

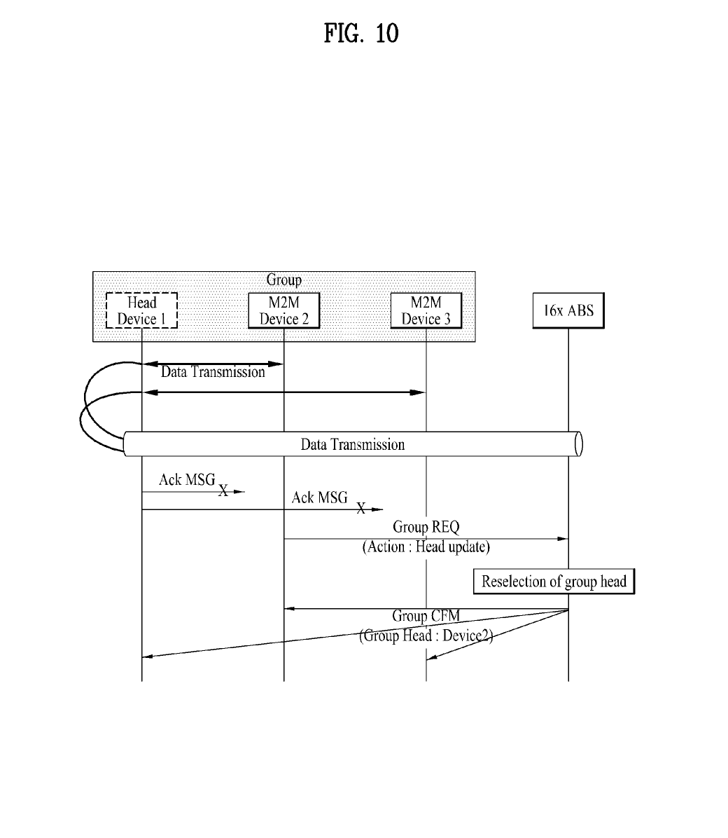

FIG. 10 is a diagram illustrating an example of a method for data transmission of member M2M devices when a group head device of an M2M group fails in data transmission.

As shown in FIG. 10, the M2M device 2 and the M2M device 3 which are the member M2M devices, transfer data for transmitting to the base station, to the M2M device 1 which is the group head device. However, data transmission to the base station may be failed due to the M2M device 1, and the M2M device 2 and the M2M device 3 may fail to receive ACK message from the M2M device 1. If the number of failure times in receiving ACK message for data transmission from the M2M device 1 exceeds a predetermined number of times, the M2M device 2 and the M2M device 3 may transmit a group request (REQ) message to the base station to request the base station to update the group head device. Alternatively, the M2M device 2 and the M2M device 3 may request the base station to update the group head device by directly transmitting data to the base station.

The base station which has received the message requesting update of the group head device may reselect the group head device and notify the M2M device 2 and the M2M device 3 of information on the reselected group head device (for example, the M2M device 2 may be reselected as a group head), through a group confirm (CFM) message. If the head device ID information has been used for the group ID information element, group ID may be reassigned to the group ID information element, whereby the M2M devices may implicitly know the group head.

The M2M devices (M2M device 2 and M2M device 3) which have received the information on the group head device (that is, M2M device 2) from the base station may update the head device to the M2M device 2. Afterwards, data transmission of the member M2M device is performed through the M2M device 2.

<Method for Presence Check of M2M Devices>

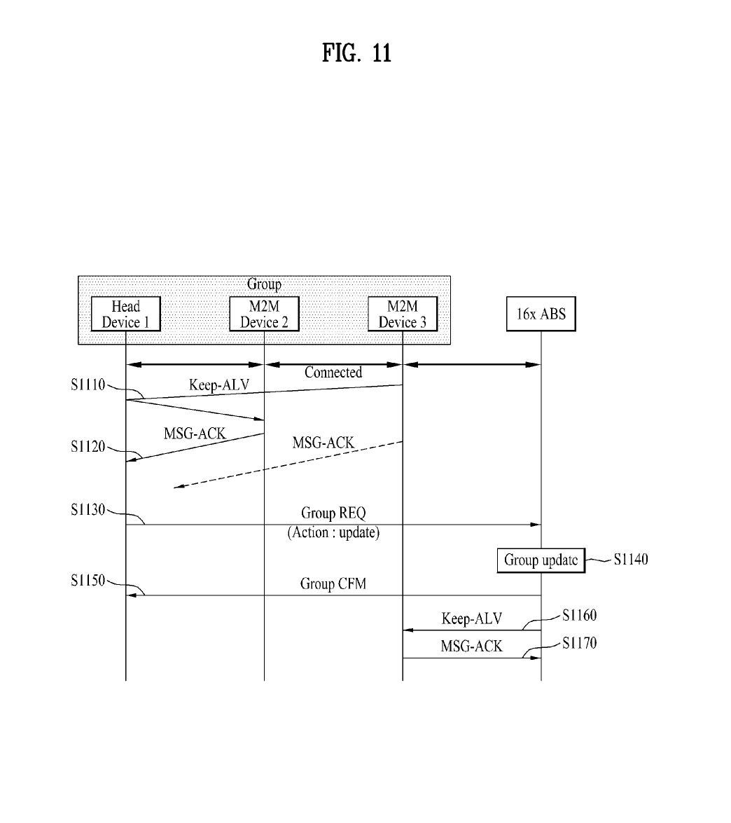

Next, presence check of the M2M devices may be required to know whether there is any status change in the M2M devices constituting groups. First of all, the base station transmits a keep-alive (Keep ALV) MAC message to a head device of any one M2M group to check the current presence of the M2M devices, and the group header device which has received the message may broadcast the Keep ALV MAC message to the member M2M devices of the group. The Keep ALV MAC message is a message transmitted from the head M2M device to know whether the member M2M devices are operated normally. If ACK response to the Keep ALV MAC message is received, the head M2M device may determine that the member M2M devices are operated normally. Next, the group head M2M device may check the current presence of the M2M devices, and details of this check will be described with reference to FIG. 11.

FIG. 11 is a diagram illustrating an example of a method for checking the current presence of M2M devices based on a group head M2M device.

Referring to FIG. 11, it is assumed that the M2M device 1, the M2M device 2, and the M2M device 3 form one group, the M2M device 1 is a head device of this group, and a network is connected between the M2M devices and between each of the M2M devices and the base station.

The M2M device 1 which is the group head device may transmit a keep-alive (Keep ALV) MAC message to the M2M device 2 and the M2M device 3, which belong to the group, to check the current presence of the member M2M devices (S1110). At this time, the M2M device 1 may transfer the keep ALV MAC message to the M2M device 2 and the M2M device 3, which belong to the group, whenever a presence check timer expires. Alternatively, the M2M device 1 which is the group head device overhears from the M2M device 2 and the M2M device 3 for a certain time period, and as a result, if data reception fails as much as the number of times more than the number of times as previously determined, or if the M2M device 2 and the M2M device 3, which perform periodic data transmission to the M2M device 1, miss transmission of several times, the M2M device 1 may broadcast the Keep ALV MAC message to the M2M device 2 and the M2M device 3 (S1110). At this time, the broadcast message may be a broadcast (multicast) message for the group or the entire broadcast message.

If the M2M device 2 and the M2M device 3 successfully receive the Keep ALV message, they should transfer a message acknowledgement (MSG-ACK) message to the M2M device 1. If the M2M device 1 fails to receive the MSG-ACK message as much as the number of times more than the previously determined number of times (for example, at least one time) (from the M2M device 3 in FIG. 11) (S1120), the M2M device transfers a group update request message (for example, Group REQ MAC message) requesting group update to the base station (S1130). In this way, a report message of the M2M device 1 may be expressed as a group REQ MAC message, for example, requesting to update of information on the group member M2M devices (for example, requesting to delete the M2M device, which fails to receive MSG-ACK, from the group).

The base station which has received the group update request message from the M2M device 1 may perform update for the requested group (S1140), and may transmit a group update confirm message (for example, Group CFM) to the M2M device 1 in response to the group update request message (S1150). At this time, the group update confirm message may include information on the M2M device deleted from the group due to update.

In the meantime, the base station may again transmit the Keep ALV message to the M2M device 3 to again check whether the M2M device 3 exists within coverage of the base station (S1160). In this case, the base station which has received the group update request message from the M2M device 1 may omit the step S1140 of updating the requested group and the step S1150 of transmitting the group update confirm message (for example, Group CFM) to the M2M device 1 in response to the group update request message.

If the MSG-ACK is transferred from the M2M device 3 to the base station (S1170), although not shown in FIG. 11, the base station may recognize that the M2M device 3 exists within coverage of the base station, and may transmit a message (for example, Group CFM), which includes information indicating that there is no change in the group, to the M2M device 1.

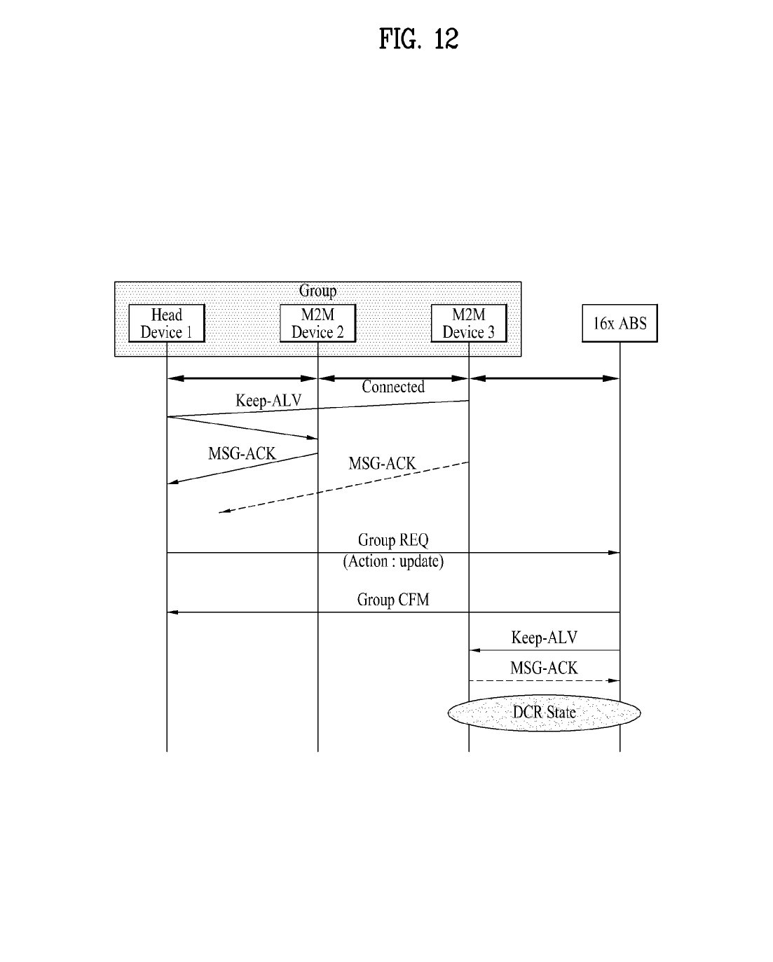

FIG. 12 is a diagram illustrating another example of a method for checking the current presence of M2M devices based on a group head M2M device.

Referring to FIG. 12, in the same manner as FIG. 11, it is assumed that the M2M device 1, the M2M device 2, and the M2M device 3 form one group, the M2M device 1 is a head device of this group, and a network is connected between the M2M devices and between each of the M2M devices and the base station. The steps S1110 to S1160 in FIG. 11 may be the same as those in FIG. 12.

In a scenario where the base station again transmits the Keep ALV message to the M2M device 3 to again check whether the M2M device 3 exists within coverage of the base station, in the same manner as FIG. 11, the step S1140 of updating the requested group through the base station which has received the group update request message from the M2M device 1 and the step S1150 of transmitting a group update confirm message (for example, Group CFM) to the M2M device 1 in response to the group update request message may be omitted.

In the same manner as the step S1160 of FIG. 11, the base station may again transmit the Keep ALV message to the M2M device 3 to again check whether the M2M device 3 exists within coverage of the base station. Afterwards, if the base station fails to receive a message acknowledgement (MSG-ACK) message from the M2M device 3, it may determine that the M2M device 3 does not exist in its coverage, and may perform the group update procedure. And, the base station may shift the M2M device 3 to a Deregistration with Context Retention (DCR) mode. The DCR mode means that the base station performs deregistration of a context maintained by the M2M device 3 which is a network entity. The base station may transfer a static context for the M2M device 3 to the M2M device 1 which is a network or group head device while shifting the M2M device 3 to the DCR mode. In this case, the M2M device 3 may perform optimized entry during later network reentry.

As described above, according to the present invention, the following advantages may be obtained. A group is formed by one or more M2M devices, and in this case, a head device of the corresponding group is defined and data are relayed to the base station through the head device, whereby network load between the base station and the M2M devices may be reduced.

Also, if the head device fails in data transmission, the group head device may be changed and information on the changed group head device may be notified, whereby communication throughput may be prevented from being deteriorated due to the failure of the group head device. Moreover, the group head device of the M2M group may check the current presence of the member M2M devices, whereby communication failure of the member M2M device may be solved quickly.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The apparatus and method for performing group based M2M communication may be used industrially for various communication systems such as IEEE 802.

1. A method for performing group-based machine to machine (M2M) communication, in which a plurality of M2M communication devices form a group and a specific M2M communication device of the group performs communication with a base station, comprising:
receiving, a message indicating that the specific M2M communication device is a head of the group, from the base station;
receiving data from one or more member M2M communication devices included in the group; and
transmitting the received data to the base station.

2. The method according to claim 1, further comprising:
transferring a bandwidth request message received from the one or more member M2M communication devices to the base station, wherein the received data is transmitted through a resource allocated by the base station for the one or more member M2M communication devices.

3. The method according to claim 1, wherein the M2M communication devices forming the group have same M2M communication type for performing same application.

4. A method for performing group-based machine to machine (M2M) communication, in which a plurality of M2M communication devices form a group and a specific M2M communication device of the group performs communication with a base station, comprising:
transmitting a first message for requesting a network registration to the base station;
receiving, a second message including information on a head M2M communication device of the group, in response to the first message; and
transferring, data for transmitting to the base station, to the head M2M communication devices based upon the second message.

5. The method according to claim 4, wherein the second message further includes transmission power value information used for data transmission from the specific M2M communication device to the head M2M communication device, and the data is transmitted to the head M2M communication device based upon the transmission power value information.

6. The method according to claim 5, wherein information on a transmission power adjustment value for the transmission power value is further transmitted during data transmission.

7. The method according to claim 4, further comprising:
transmitting a third message for bandwidth request to the head M2M communication device based upon the second message; and
receiving, a fourth message including resource allocation information for data transmission, from the base station in response to the third message,
wherein the step of transmitting data includes transferring the data to the head M2M communication device through a resource allocated by additionally using the fourth message.

8. A method for performing group-based machine to machine (M2M) communication, in which a plurality of M2M communication devices form a group and a specific M2M communication device of the group performs communication with a base station, comprising:
transmitting data to a head M2M communication device of the group;
transmitting, a first message for requesting to update the head M2M communication device of the group, to the base station if an acknowledgement (ACK) message is not received from the head M2M communication device in response to the data transmitted to the head M2M communication device of the group; and
receiving, a second message including information on an updated head M2M communication device of the group, from the base station in response to the first message.

9. The method according to claim 8, wherein the first message is transmitted if the ACK message is not received from the base station as much as the number of times previously determined for data transmitted to the head M2M communication device several times.

10. A method for performing group-based machine to machine (M2M) communication, in which a plurality of M2M communication devices form a group and an M2M communication device of the group performs communication with a base station, comprising:
receiving, a first message for requesting to update a head M2M communication device of the group, from a specific member M2M communication device not the head M2M communication device of the group;
determining a new head M2M communication device of the group based upon the first message; and
transmitting, a second message including information on the new head M2M communication device, to the specific member M2M device, in response to the first message.

11. A method for performing group-based machine to machine (M2M) communication, in which a plurality of M2M communication devices form a group and a head M2M communication device of the group performs communication with a base station, comprising:
transmitting a first message for presence check of one or more M2M communication devices of the group, to the one or more M2M communication devices; and
transmitting a second message requesting to update member M2M communication device information of the group, to the base station if an acknowledgement (ACK) message of the first message is not received from the one or more M2M communication devices.

12. The method according to claim 11, further comprising:
receiving a third message including updated information for the member M2M communication device of the group, in response to the second message.

13. The method according to claim 11, wherein the second message is transmitted if there is a member M2M communication device that does not transmit the ACK message as much as the number of times previously determined for the first message transmitted several times.

14. The method according to claim 11, wherein the second message includes information on the member M2M communication device that does not transmit the ACK message in response to the first message.

15. A method for performing group-based machine to machine (M2M) communication, in which a base station performs communication with a head M2M communication device of a plurality of M2M communication devices forming a group, comprising:
receiving a first message for requesting to update member M2M communication device information of the group from the head M2M communication device of the group;
updating the member M2M communication device information based upon the first message; and
transmitting, a second message including information on the updated member M2M communication device, to the head M2M communication device,
wherein the first message includes information on an M2M communication device that does not transmit an acknowledgement (ACK) message in response to a third message transmitted for presence check from one or more M2M communication devices.

16. The method according to claim 15, further comprising:
transmitting a fourth message for presence check to the member M2M communication device that does not transmit the ACK message; and
performing deregistration of context maintained with the member M2M communication device that does not transmit the ACK message if the ACK message is not received in response to the fourth message.

17. A base station for performing group-based machine to machine (M2M) communication with a head M2M communication device of a plurality of M2M communication devices forming a group, the base station comprising:
a receiver configured to receive a first message for requesting to update member M2M communication device information of the group from the head M2M communication device of the group;
a processor configured to update the member M2M communication device information based upon the first message; and
a transmitter configured to transmit a second message including information on the updated member M2M communication device, to the head M2M communication device,
wherein the first message includes information on an M2M communication device that does not transmit an acknowledgement (ACK) message in response to a third message transmitted for presence check from one or more M2M communication devices.

18. A machine to machine (M2M) communication device performs communication with a base station, in which a group is formed by a plurality of M2M communication devices, the M2M communication device comprising:
a receiver configured to receive a message indicating that the M2M communication device is a head device of the group, from the base station and to receive data from one or more member M2M communication devices included in the group; and
a transmitter configured to transmitting the received data to the base station.
